(19) United States
(12) Patent Application Publication
(10) Pub. No.: US 2020/0372032 A1
(43) Pub. Date: Nov. 26, 2020

(54) DATA TRACKING APPARATUS, METHOD, AND NON-TRANSITORY TANGIBLE MACHINE-READABLE MEDIUM THEREOF WITH A USER INTERFACE

(71) Applicant: BigObject Inc., Taipei City (TW)

(72) Inventors: Tyng-Rong ROAN, Taipei City (TW); Wenwey HSEUSH, Taipei City (TW)

(21) Appl. No.: 16/450,634

(22) Filed: Jun. 24, 2019

(30) Foreign Application Priority Data
May 23, 2019 (TW) 108117895

(51) Int. Cl. G06F 16/2455; G06F 16/2458; G06F 16/248; G06F 16/23

(52) U.S. Cl. CPC G06F 16/24568; G06F 16/2393; G06F 16/248; G06F 16/2462

(57) ABSTRACT

A data tracking apparatus, method, and non-transitory tangible machine-readable medium thereof are provided. The data tracking apparatus includes a storage device, a display screen, and a processor. The storage device stores a fact dataset, wherein the fact dataset is continuously updated by a stream of data. The display screen displays a user interface, wherein the user interface comprises a plurality of options related to the fact dataset. The processor establishes a tracking rule in response to one of the options being selected and updates the user interface so that the user interface further includes a tracking item corresponding to the tracking rule. The processor derives a tracking result by querying the updated fact dataset according to the tracking rule in response to the tracking item being selected.

### CLAIM FOR PRIORITY

This application claims priority to Taiwan Patent Application No. 108117895 filed on May 23, 2019, which is hereby incorporated by reference in its entirety.

### CROSS-REFERENCES TO RELATED APPLICATIONS

Not applicable.

### BACKGROUND OF THE INVENTION

### Field of the Invention

The present invention relates to a data tracking apparatus, method, and non-transitory tangible machine-readable medium thereof. Specifically, the data tracking apparatus, method, and non-transitory tangible machine-readable medium thereof according to the present invention provide a user interface having the dynamic tracking function.

### Descriptions of the Related Art

In the recent trend of big data, a special category of data, referred to as streaming of data (or data stream or stream data), has been identified. Stream of data has the following three main characteristics, including: (1) being non-stop and generated from the real world in real time order, (2) being immutable and collected as time series data, and (3) the more recent data is more valuable in business. Data generated from Internet of Things (IoT), mobile applications (APPs), or large-scale Web services often falls in this category.

Although some data analysis tools have been developed for stream of data, these data analysis tools can only be used in specific application environment and are not inconvenient to use. Taking Google Analytics (“GA” for short, which is a data analysis tool developed by Google, LLC.) as an example, a professional having the ability of programing has to insert some tracking codes into a web page or an application in advance and then only certain data of the website or application (specified in the tracking code) can be analyzed. Accordingly, a user interface that is convenient to use and can achieve dynamic tracking is in an urgent need for big data, especially for the ever-changing stream of data.

### SUMMARY OF THE INVENTION

To solve the aforesaid problems, the present invention provides a data tracking apparatus, method, and non-transitory tangible machine-readable medium thereof.

The data tracking apparatus provided by the present invention comprises a storage device, a display screen, and a processor, wherein the processor is electrically connected to the storage device and the display screen. The storage device stores a fact dataset, wherein the fact dataset is continuously updated by a stream of data. The display screen displays a user interface, wherein the user interface comprises a plurality of options related to the fact dataset. The processor establishes a tracking rule in response to one of the options being selected and updates the user interface so that the user interface further comprises a tracking item corresponding to the tracking rule. The processor further derives a tracking result by querying the updated fact dataset according to the tracking rule in response to the tracking item being selected.

The data tracking method provided by the present invention is adapted for use in an electronic computing apparatus, wherein the electronic computing apparatus stores a fact dataset.

The data tracking method comprises the following steps of: (a) updating the fact dataset by a steam of data continuously, (b) displaying a user interface on a display screen, wherein the user interface comprises a plurality of options related to the fact dataset, (c) establishing a tracking rule in response to one of the options being selected, (d) updating the user interface so that the user interface further comprises a tracking item corresponding to the tracking rule, and (e) deriving a tracking result by querying the updated fact dataset according to the tracking rule in response to the tracking item being selected.

The non-transitory tangible machine-readable medium provided by the present invention stores a computer program, wherein the computer program comprises a plurality of codes. When the codes of the computer program are loaded into an electronic computing apparatus, the codes executed by the electronic computing apparatus performs the data tracking method described in the above paragraph.

The user interface provided by the data tracking technology (including the apparatus, method, and non-transitory tangible machine-readable medium) of the present invention allows a user to secure a target audience related to a fact dataset by simple operation(s) (which is equivalent to tagging the target audience with some label) via simple operations. In response to the operations performed by the user, the data tracking technology provided by the present invention establishes a tracking rule for the target audience and establishes a corresponding tracking item on the user interface for subsequent tracking. Thereafter, the user can track the target audience that has been secured previously by selecting the tracking item on the user interface and thereby achieve the effect of one-click tracking.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A illustrates a schematic view of the data tracking apparatus 1 of the first embodiment;

FIG. 1B illustrates a schematic view of the user interface 14 in a specific example;

FIG. 1C illustrates a schematic view of the user interface 14 after the user selects the statistical data 20a;

FIG. 1D illustrates a schematic view of the user interface 14 after the user selects a newly added tracking item 16;

FIG. 1E illustrates a schematic view of the user interface 14 after the user operates on the tracking item data 160;

FIG. 1F illustrates a schematic view after the user interface 14 is activated again by the user;

FIG. 1G illustrates a schematic view after the user selects the tracking item 182;

FIG. 1H illustrates another schematic view after the user selects the tracking item 182; and

FIG. 2 is a flowchart of the data tracking method of the second embodiment.

### DESCRIPTION OF THE PREFERRED EMBODIMENT

In the following description, a data tracking apparatus, method, and non-transitory tangible machine-readable medium thereof provided by the present invention will be explained with reference to embodiments thereof. However, these embodiments of the present invention are not intended to limit the present invention to any environment, applications, or implementations described in these embodiments. Therefore, description of these embodiments is only for purpose of illustration rather than to limit the scope of the present invention. It shall be appreciated that, in the following embodiments and the attached drawings, elements unrelated to the present invention are omitted from depiction. Furthermore, dimensions of elements and dimensional proportions among individual elements in the attached drawings are provided only for ease of depiction and description, but not to restrict the scope of the present invention.

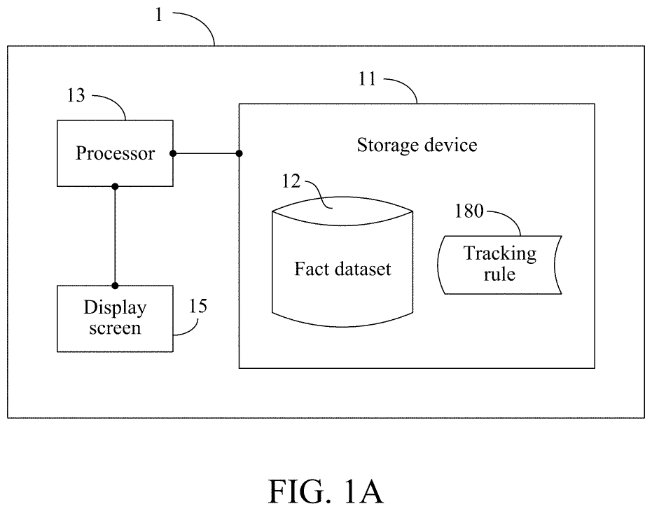

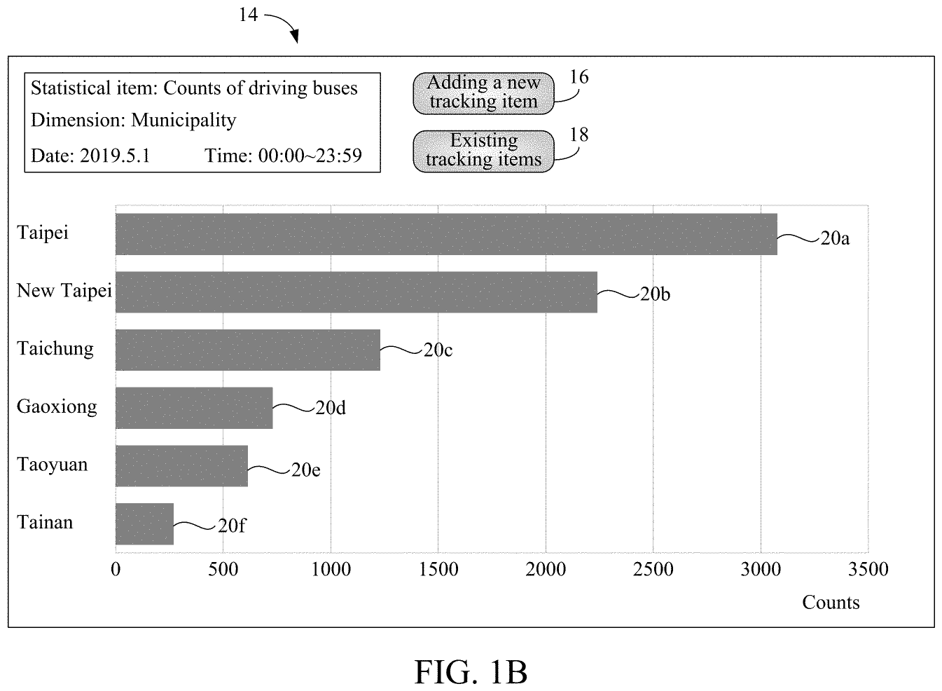

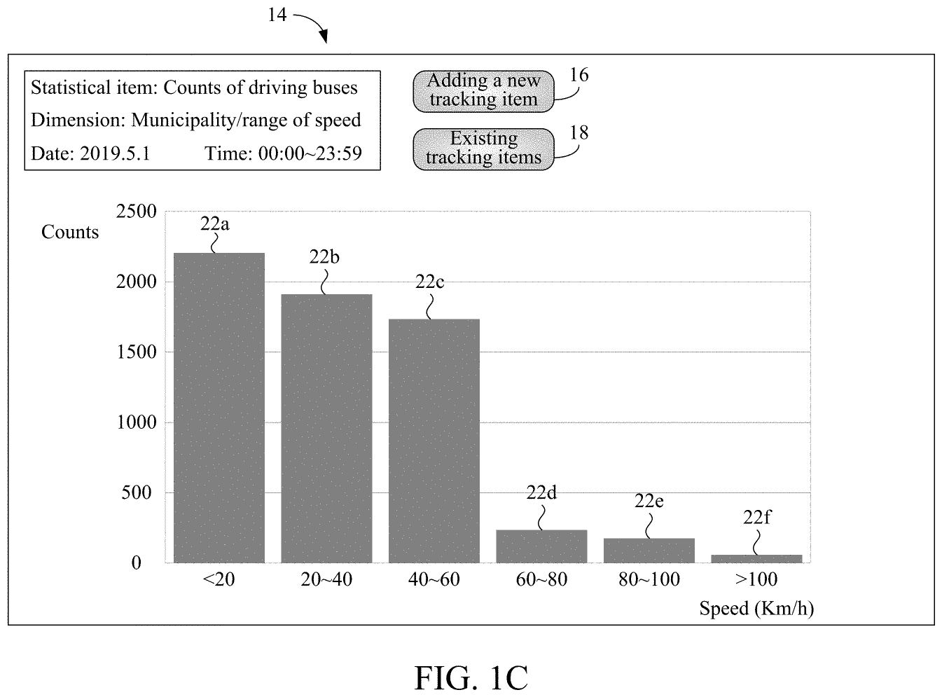

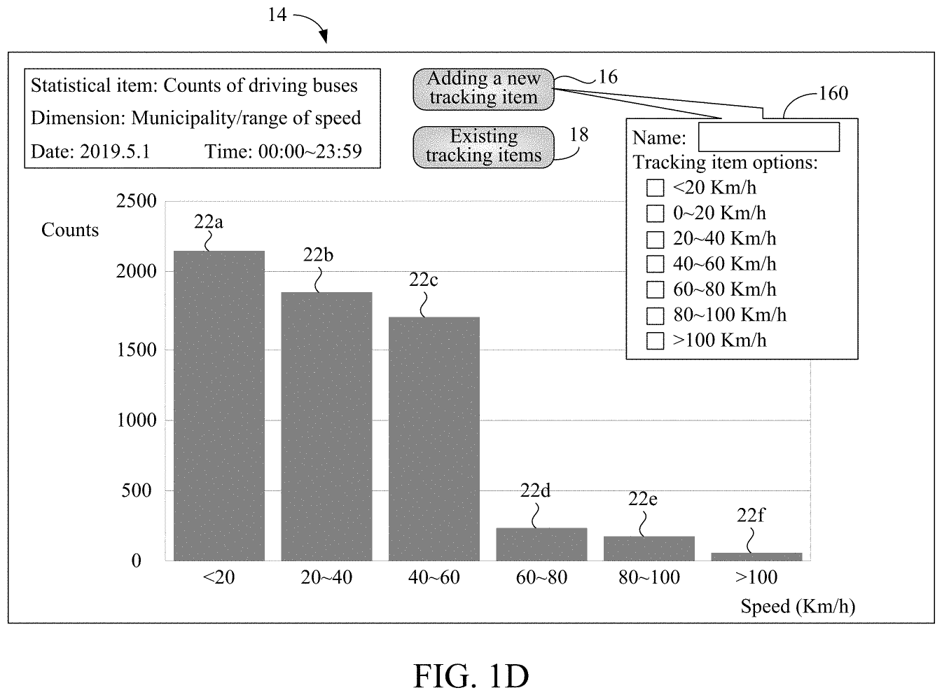

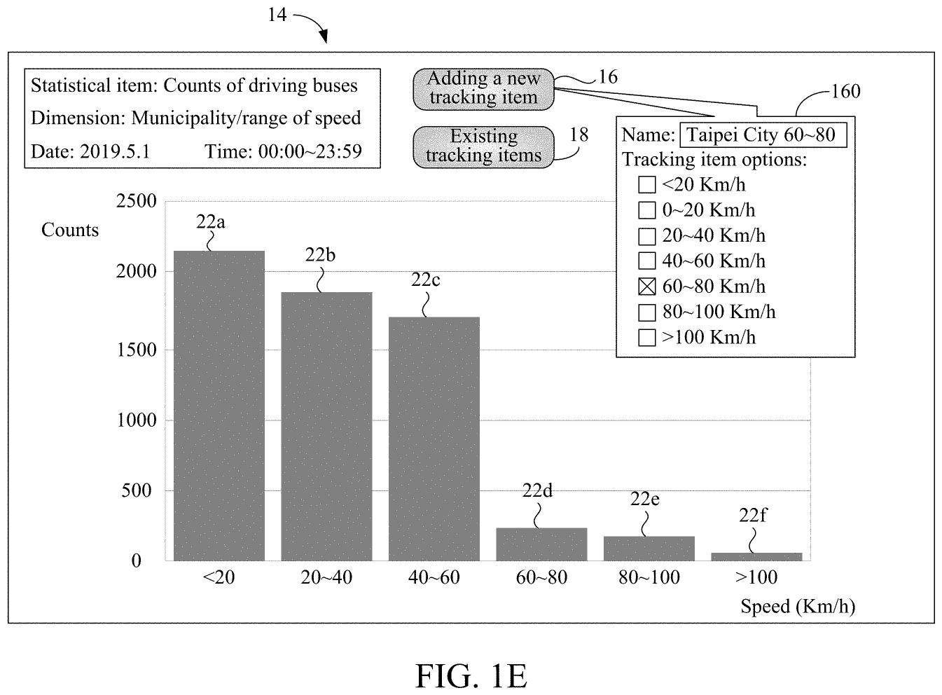

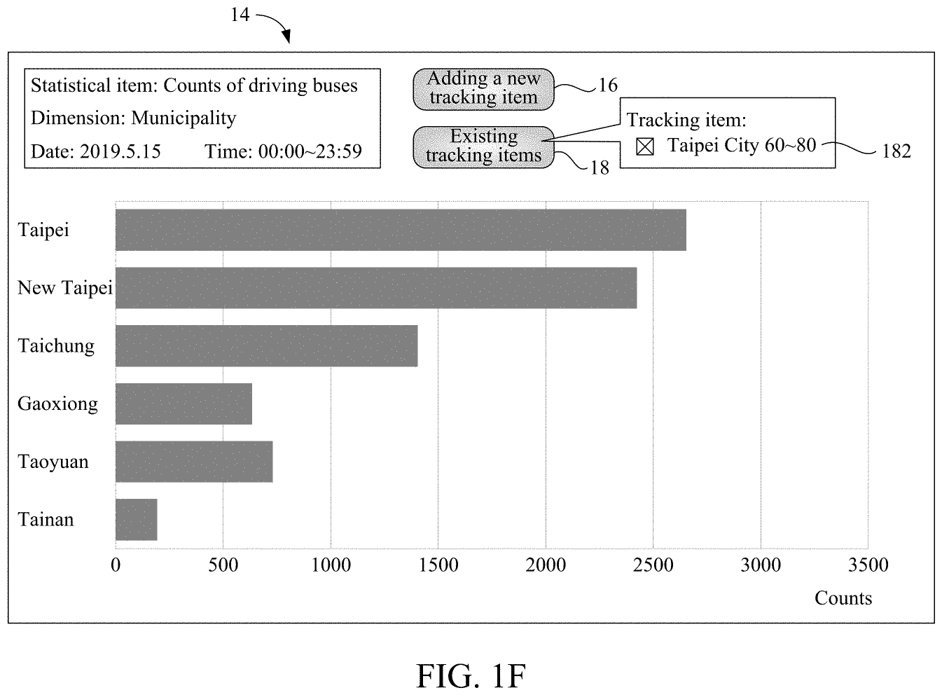

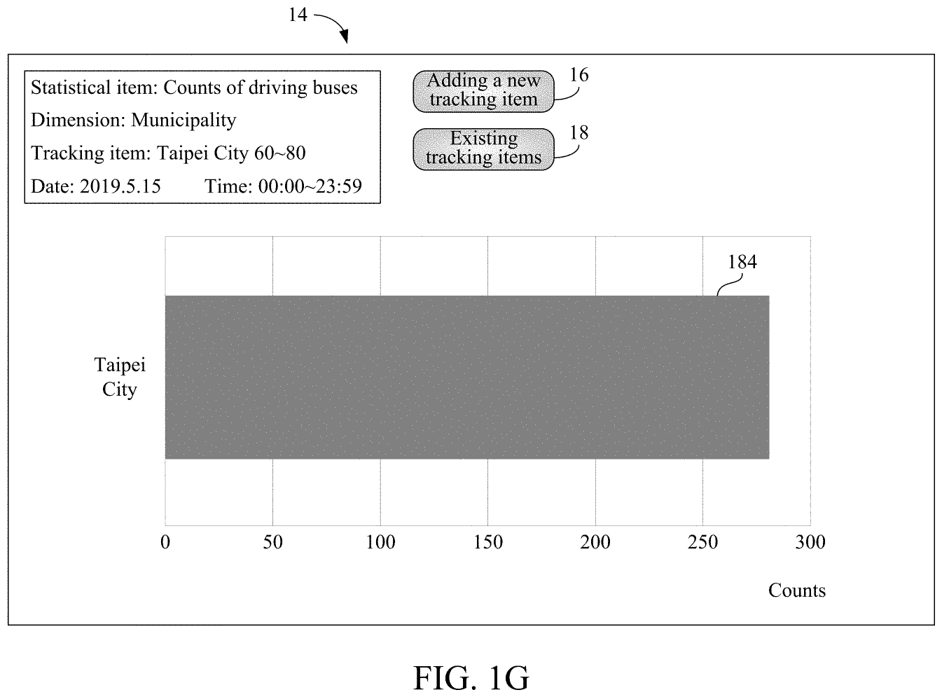

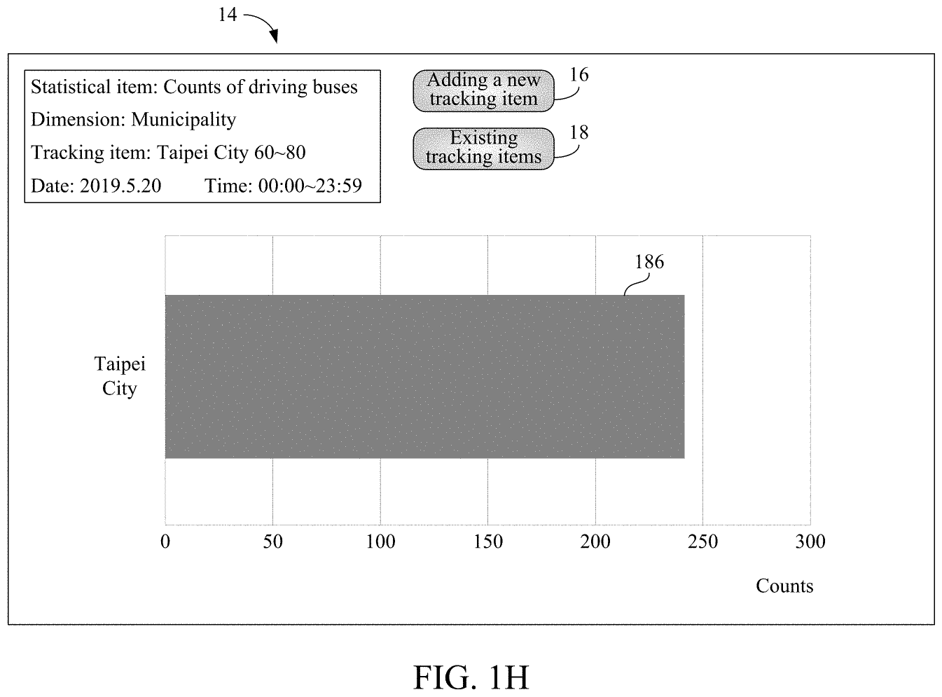

A first embodiment of the present invention is a data tracking apparatus 1 and a schematic view of which is depicted in FIG. 1A. The data tracking apparatus 1 comprises a storage device 11, a processor 13, and a display screen 15, wherein the processor 13 is electrically connected to the storage device 11 and the display screen 15. The storage device 11 may be a hard disk (e.g., a solid-state hard disk) or other non-transitory computer-readable storage medium or apparatus that can be installed with various kinds of data storage system and is well-known to those of ordinary skill in the art. The processor 13 may be one of various processors, Central Processing Units (CPUs), microprocessors, Digital Signal Processors (DSPs), or any other computing apparatuses having the same functions and well-known to those of ordinary skill in the art. The display screen 15 may be a Liquid Crystal Display (LCD), an Organic Light Emitting Diode (OLED) screen, an electronic paper screen, or any other apparatus that is capable of displaying digital information.

The storage device 11 stores a fact dataset 12. The fact dataset 12 defines a plurality of attributes (not shown) and comprises a plurality of fact records (not shown), wherein each of the fact records comprises a plurality of fact data (not shown) corresponding to the attributes one-to-one. Please note that the way that the storage device 13 stores the fact dataset 12 is not limited by the present invention. For example, the fact dataset 12 may be stored in a database management system installed in the storage device 13, but it is not limited thereto.

The fact dataset 12 is continuously updated by a stream of data (not shown). In some embodiments, the data tracking apparatus 1 may be provided with a transceiving interface (not shown) to continuously receive a stream of data and then the processor 13 updates the fact dataset 12 by the new fact data in the stream of data (i.e., adding new fact records to the fact dataset 12 to cover the new fact data). The aforesaid transceiving interface may be a wired interface or a wireless interface, which is electrically connected to the processor 13. The aforesaid stream of data may be data generated by an Internet of Things (IoT) system, data generated by a mobile application, or data generated by a large-scale Web service, but it is not limited thereto.

In this embodiment, the display screen 15 displays a user interface 14, wherein the user interface 14 comprises a plurality of options related to the fact dataset 12. The options comprised in the user interface 14 may be selected by a user (e.g., clicking the option to be selected by a mouse, touching the option to be selected on the touch display screen, but it is not limited thereto) so that the user can inspect the fact dataset 12 from different levels. In some embodiments, the options comprised in the user interface 14 may be all of or part of the attributes of the fact dataset 12. In some embodiments, the options comprised in the user interface 14 may be a plurality of statistical data related to the fact dataset 12. In some embodiments, the options comprised in the user interface 14 may be all of or part of the attributes of the fact dataset 12 and a plurality of statistical data related to the fact dataset 12.

For better understanding, a specific example is provided herein for the subsequent description. However, please note that the specific example is not used to limit the scope of the present invention. In the specific example, the fact records included in the fact dataset 12 are bus travel data of cities in Taiwan and the user interface 14 is an interface for inspecting the fact dataset 12.

It is assumed that a user activates the user interface 14 at a certain time point on a certain day to inspect the fact dataset 12, and the user interface 14 shown on the display screen 15 in response to the activation of the user interface 14 by the user is illustrated in FIG. 1B. Specifically, the user interface 14 shown in FIG. 1B comprises a plurality of statistical data 20a, 20b, 20c, 20d, 20e, and 20f related to the fact dataset 12, and the statistical data 20a, 20b, 20c, 20d, 20e, and 20f are the statistical data of traveling buses in municipalities of Taiwan on the day when the user activates the user interface 14 (e.g., May 1, 2019). The statistical data 20a, 20b, 20c, 20d, 20e, and 20f are a plurality of options that can be selected by the user on the user interface 14.

It is assumed that the user selects one of the options (i.e., the statistical data 20a, 20b, 20c, 20d, 20e, and 20f) on the user interface 14 to drill down. For convenience, it is assumed that the user selects the statistical data 20a (i.e., the counts of travelling buses in Taipei City). In response to the statistical data 20a being selected by the user, the user interface 14 shown on the display screen 15 is changed as illustrated in FIG. 1C. Specifically, the user interface 14 of FIG. 1C comprises a plurality of statistical data 22a, 22b, 22c, 22d, 22e, and 22f after drilling down, wherein the statistical data 22a, 22b, 22c, 22d, 22e, and 22f are the statistical data of driving speeds of the driving buses in Taipei City on the day when the user activates the user interface 14 (e.g., May 1, 2019). The statistical data 22a, 22b, 22c, 22d, 22e, and 22f are also a plurality of options that can be selected by the user on the user interface 14.

During the process of inspecting the fact dataset 12 from different levels via the user interface 14, the user may secure a target audience by operating on the user interface 14 and tag a label to the target audience for subsequent tracking. In this specific example, the user interface 14 further comprises an option of adding a new tracking item 16, and the user may select the option of adding a new tracking item 16 for securing the target audience and therby tag the target audience by a label for subsequent tracking.

For better understanding, it is assumed that when the user inspects the fact dataset 12 on the user interface 14 as shown in FIG. 1C, the user decides to secure the counts of driving buses having a driving speed in the range of 60 to 80 Km/h in Taipei City as the target audience for subsequent tracking. After the user selects the option of adding a new tracking item 16 on the user interface 14, the user interface 14 shown on the display screen 15 is changed to further comprise a list of tracking item options 160 as shown in FIG. 1D. The list of tracking item options 160 comprises a plurality of tracking item options, and the tracking item options correspond to the options (i.e., the statistical data 22a, 22b, 22c, 22d, 22e, and 22f) in the user interface 14 shown in FIG. 1D that are related to the fact dataset 12.

Please refer to FIG. 1E, which shows that the user selects the tracking item option “60 to 80 Km/h” in the list of tracking item options 160. It means that the user selects the audience represented by the statistical data 22d as the target audience (i.e., the counts of driving buses having a driving speed in the range of 60 to 80 Km/h in Taipei City). It also means that the user tags this target audience with a label. In response to the user selecting the tracking item option “60 to 80 Km/h” in the list of tracking item options 160, the processor 13 establishes a tracking rule 180 for the target audience (i.e., establishing a querying instruction of “the counts of driving buses having a driving speed in the range of 60 to 80 Km/h in Taipei City,” which is dependent on the database management system storing the fact dataset 12), stores the tracking rule 180 in the storage device 11, and updates the user interface 14 so that the user interface 14 further comprises a tracking item 182 corresponding to the tracking rule 180 (which will be described later). Additionally, the list of tracking item options 160 may further comprise a name field so that the user can designate a name representing the target audience as shown in FIG. 1E.

After the user tags the target audience (i.e., the counts of driving buses having a driving speed in the range of 60 to 80 Km/h in Taipei City) with a label and establishes the tracking rule via the user interface 14 provided by the data tracking apparatus 1, the user may track the target audience that is previously secured via the user interface 14 when there is a need. In this specific example, the user interface 14 comprises an option regarding existing tracking items 18, and the user may select the option regarding the existing tracking item 18 for further operation and thereby track the target audience that has been secured previously.

It is assumed that the user activates the user interface 14 at a certain time point on a certain day thereafter to inspect the fact dataset 12 again. In response to the user interface 14 being activated by the user, the display screen 15 shows the user interface 14 as illustrated in FIG. 1F. Similarly, the user interface 14 shown in FIG. 1F comprises a plurality of statistical data that are related to the fact dataset 12, wherein the statistical data are the statistical data of driving buses in municipalities of Taiwan on the day when the user activates the user interface 14 this time (e.g., May 15, 2019). Similarly, these statistical data are also a plurality of options that can be selected by the user on the user interface 14, and the details are not repeated herein.

Since the user wants to track the target audience that has been secured previously, the user selects the option regarding the existing tracking items 18. In response to the option of the existing tracking items 18 being selected by the user, the user interface 14 shown in the display screen 15 is changed to further comprise the tracking item 182 that has been established previously as shown in FIG. 1F. The user selects the tracking item 182. In response to the tracking item 182 being selected by the user, the processor 13 derives a tracking result 184 by querying the updated fact dataset 12 according to the tracking rule 180 corresponding to the tracking item 182. As shown in FIG. 1G, the tracking result 184 is the counts of the driving buses having a driving speed in the range of 60 to 80 Km/h in Taipei City on the day when the user activates the user interface 14 for this time (e.g., May 15, 2019).

Likewise, the user may track the target audience that has been secured previously again via performing the same operation(s) subsequently. For example, the user tracks the target audience that has been secured previously again on May 20, 2019. Specifically, the user performs the same operation(s) on the user interface 14 and the processor 13 derives a tracking result 186 by querying the updated fact dataset 12 according to the tracking rule 180 corresponding to the tracking item 182 again as shown in FIG. 1H. By comparing FIG. 1G and FIG. 1H, it is learned that different tracking results will be obtained when tracking the target audience at different times due to the fact dataset 12 being updated by a stream of data continuously.

In the above specific example, the options comprised in the user interface 14 that are related to the fact dataset 12 are a plurality of statistical data that are related to the fact dataset 12. Please note that, in some embodiments, the options comprised in the user interface 14 that are related to the fact dataset 12 may be all of or part of the attributes of the fact dataset 12. In some embodiments, the options comprised in the user interface 14 may be all of or part of the attributes of the fact dataset 12 along with the statistical data related to the fact dataset 12. According to the above description, those of ordinary skill in the art shall appreciate that no matter the options comprised in the user interface 14 that are related to the fact dataset 12 belong to which kind(s), the user can secure a target audience on the user interface 14 via the aforesaid operations. In response to the operations performed by the user, the processor 13 will establish a tracking rule for the target audience and establish a corresponding tracking item on the user interface 14 for the subsequent tracking. The details will not be repeated herein.

According to the above description, the user interface 14 provided by the data tracking apparatus 1 allows a user to secure a target audience related to the fact dataset 12 (which is equivalent to tagging the target audience with a label) via simple operations. In response to the operations performed by the user, the data tracking apparatus 1 establishes a tracking rule for the target audience and establishes a corresponding tracking item on the user interface 14 for subsequent tracking. Thereafter, the user can track the target audience that has been secured previously by selecting the tracking item on the user interface 14 and thereby achieve the effect of one-click tracking.

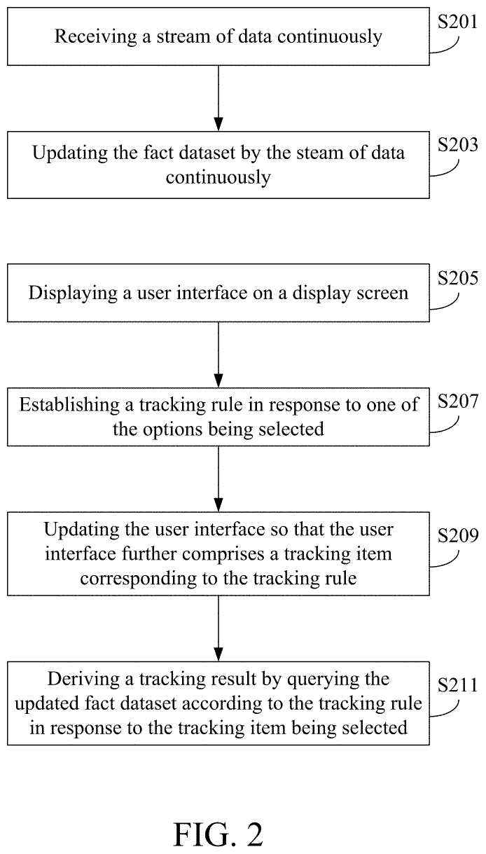

A second embodiment of the present invention is a data tracking method and a flowchart of which is illustrated in FIG. 2. The data tracking method is adapted for use in an electronic computing apparatus, such as the data tracking apparatus 1 in the first embodiment. The electronic computing apparatus stores a fact dataset, wherein the fact dataset defines a plurality of attributes and comprises a plurality of fact records and each of the fact records comprises a plurality of fact data corresponding to the attributes one-to-one. The data tracking method at least comprises the steps S201 to S211. The steps S201 and S203 are related to receiving of a stream of data and updating of the fact dataset, while the steps S205 to S211 are related to securing and tracking a target audience via a user interface that is easy to operate.

In this embodiment, the steps S201 and S203 are continuously executed. That is, the steps S201 and S203 will be executed as long as there is new fact data in the stream of data. Specifically, in step S201, the electronic computing apparatus receives a stream of data continuously. In step S203, the electronic computing apparatus updates the fact dataset by the steam of data continuously (i.e., new fact records will be continuously added to the fact dataset).

In another aspect, in step S205, the electronic computing apparatus displays a user interface on a display screen, wherein the user interface comprises a plurality of options related to the fact dataset. In some embodiments, the options comprised in the user interface include all of or part of the attributes of the fact dataset. In some embodiments, the data tracking method further executes a step (not shown) of displaying a plurality of statistical data related to the fact dataset on the display screen. For those embodiments, the options comprised in the user interface comprise the statistical data. In some embodiments, the options comprised in the user interface may comprise all of or part of the attributes of the fact dataset as well as the statistical data displayed on the display screen.

Thereafter, in step S207, the electronic computing apparatus establishes a tracking rule in response to one of the options being selected. In step S209, the electronic computing apparatus updates the user interface so that the user interface further comprises a tracking item corresponding to the tracking rule. In some embodiments, the data tracking method further comprises a step of storing the tracking rule (not shown). In step S211, the electronic computing apparatus derives a tracking result by querying the updated fact dataset according to the tracking rule in response to the tracking item being selected.

In addition to the aforesaid steps, the data tracking method of the second embodiment can execute all the operations and steps of the data tracking apparatus 1 set forth in the first embodiment, have the same functions, and deliver the same technical effects as the first embodiment. How the second embodiment executes these operations and steps, has the same functions, and delivers the same technical effects as the first embodiment will be readily appreciated by those of ordinary skill in the art based on the explanation of the first embodiment, and thus will not be further described herein.

The data tracking method described in the second embodiment may be implemented as a computer program having a plurality of codes. The computer program is stored in a non-transitory tangible machine-readable medium, which may be a read only memory (ROM), a flash memory, a floppy disk, a hard disk, a compact disk (CD), a digital versatile disc (DVD), a mobile disk, a database accessible to networks, or any other storage media with the same function and well known to those of ordinary skill in the art. After the codes of the computer program loaded into an electronic computing apparatus (e.g., the data tracking apparatus 1), the computer program executes the data tracking method as described in the second embodiment.

According to the above descriptions, the user interface provided by the data tracking technology (including the apparatus, method, and non-transitory tangible machine-readable medium) of the present invention allows a user to secure a target audience related to a fact dataset (which is equivalent to tagging the target audience with a label) via simple operations. In response to the operations performed by the user, the data tracking technology provided by the present invention establishes a tracking rule for the target audience and establishes a corresponding tracking item on the user interface for subsequent tracking. Thereafter, the user can track the target audience that has been secured previously by selecting the tracking item on the user interface and thereby achieve the effect of one-click tracking.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A data tracking apparatus, comprising:
a storage device, storing a fact dataset, the fact dataset being continuously updated by a stream of data;
a display screen, displaying a user interface, the user interface comprising a plurality of options related to the fact dataset;
a processor, being electrically connected to the storage device and the display screen and being configured to establish a tracking rule in response to one of the options being selected and update the user interface so that the user interface further comprises a tracking item corresponding to the tracking rule,
wherein the processor further derives a tracking result by querying the updated fact dataset according to the tracking rule in response to the tracking item being selected.

2. The data tracking apparatus of claim 1, wherein the fact dataset defines a plurality of attributes and the options comprised in the user interface comprise the attributes.

3. The data tracking apparatus of claim 1, wherein the display screen further displays a plurality of statistical data related to the fact dataset and the options comprised in the user interface comprise the statistical data.

4. The data tracking apparatus of claim 1, wherein the fact dataset defines a plurality of attributes, the display screen further displays a plurality of statistical data related to the fact dataset, and the options comprised in the user interface comprise the attributes and the statistical data.

5. The data tracking apparatus of claim 1, wherein the storage device further stores the tracking rule.

6. A data tracking method for use in an electronic computing apparatus, the electronic computing apparatus storing a fact dataset, and the data tracking method comprising the following steps of:
updating the fact dataset by a steam of data continuously;
displaying a user interface on a display screen, wherein the user interface comprises a plurality of options related to the fact dataset;
establishing a tracking rule in response to one of the options being selected;
updating the user interface so that the user interface further comprises a tracking item corresponding to the tracking rule; and
deriving a tracking result by querying the updated fact dataset according to the tracking rule in response to the tracking item being selected.

7. The data tracking method of claim 6, wherein the fact dataset defines a plurality of attributes and the options comprised in the user interface comprises the attributes.

8. The data tracking method of claim 6, further comprising the following step of:
displaying a plurality of statistical data related to the fact dataset on the display screen;
wherein the options comprised in the user interface comprise the statistical data.

9. The data tracking method of claim 6, wherein the fact dataset defines a plurality of attributes, and the data tracking method further comprises the following step:
displaying a plurality of statistical data related to the fact dataset on the display screen;
wherein the options comprised in the user interface comprise the attributes and the statistical data.

10. The data tracking method of claim 6, further comprising a step of storing the tracking rule.

11. A non-transitory tangible machine-readable medium, storing a computer program comprising a plurality of codes, the codes being able to perform a data tracking method when the computer program is loaded into an electronic computing apparatus, the electronic computing apparatus storing a fact dataset, the data tracking method comprising the following steps of:
updating the fact dataset by a steam of data continuously;
displaying a user interface on a display screen, wherein the user interface comprises a plurality of options related to the fact dataset;
establishing a tracking rule in response to one of the options being selected;
updating the user interface so that the user interface further comprises a tracking item corresponding to the tracking rule; and
deriving a tracking result by querying the updated fact dataset according to the tracking rule in response to the tracking item being selected.

12. The non-transitory tangible machine-readable medium of claim 11, wherein the fact dataset defines a plurality of attributes and the options comprised in the user interface comprise the attributes.

13. The non-transitory tangible machine-readable medium of claim 11, wherein the data tracking method further comprising the following step of:
displaying a plurality of pieces of statistical data related to the fact dataset on the display screen;
wherein the options comprised in the user interface comprise the statistical data.

14. The non-transitory tangible machine-readable medium of claim 11, wherein the fact dataset defines a plurality of attributes, and the data tracking method further comprises the following step:
displaying a plurality of statistical data related to the fact dataset on the display screen;
wherein the options comprised in the user interface comprise the attributes and the statistical data.

15. The non-transitory tangible machine-readable medium of claim 11, wherein the data tracking method further comprises a step of storing the tracking rule.
